(19) United States
(12) Patent Application Publication
(10) Pub. No.: US 2016/0211523 A1
(43) Pub. Date: Jul. 21, 2016

(54) ELECTRODE FOR LITHIUM ION SECONDARY CELLS, AND LITHIUM ION SECONDARY CELL

(71) Applicant: TOPPAN PRINTING CO., LTD., Tokyo (JP)

(72) Inventors: Hiroshi UEDA, Tokyo (JP); Masahiro UENO, Tokyo (JP); Noriyuki ITO, Tokyo (JP)

(73) Assignee: TOPPAN PRINTING CO., LTD., Tokyo (JP)

(21) Appl. No.: 15/083,674

(22) Filed: Mar. 29, 2016

Related U.S. Application Data
(63) Continuation of application No. PCT/JP2014/075823, filed on Sep. 29, 2014.

(30) Foreign Application Priority Data
Sep. 30, 2013 (JP) 2013-203874

(51) Int. Cl. H01M 4/62; H01M 4/131; H01M 10/0568; H01M 4/66; H01M 10/0569; H01M 10/0525; H01M 4/505

(52) U.S. Cl. CPC H01M 4/622; H01M 10/0525; H01M 4/131; H01M 4/505; H01M 4/623; H01M 4/625; H01M 4/661; H01M 10/0569; H01M 10/0568; H01M 2004/028

(57) ABSTRACT

An electrode of the invention for lithium ion secondary cells comprises a positive electrode current collector, a first positive electrode layer having a first binder made of a synthetic polymer having an ester bond and a first conductive agent and formed on the positive electrode current collector, and a second positive electrode layer having a positive electrode active substance, a second binder and a second conductive agent and formed on a surface of the first positive electrode layer opposite to the surface at which the positive electrode current collector is formed.

### CROSS-REFERENCE TO RELATED PATENT APPLICATIONS

This application is a continuation application filed under 35 U.S.C. §111(a) claiming the benefit under 35 U.S.C. §§120 and 365(c) of PCT International Application No. PCT/JP2014/075823 filed on Sep. 29, 2014, which is based upon and claims the benefit of priority of Japanese Application No. 2013-203874, filed on Sep. 30, 2013, the entire contents of them all are hereby incorporated by reference.

### TECHNICAL FIELD

This invention relates to an electrode for lithium ion secondary cells subjected to measures against overcharge, and a lithium ion secondary cell provided with this electrode for lithium ion secondary cells.

### BACKGROUND

Along with the popularization of electronic devices such as note-type computers, cell phones, digital cameras and the like, there has been a growing demand for secondary cells for driving these electronic devices. Recently, advances in sophistication of these electronic devices entail increased consumption power and an expected downsizing trend, for which secondary cells are required to have improved energy density and output density. The most promising candidate, which has been considered as a secondary cell capable of achieving high energy density and high output density, is a secondary cell making use of a non-aqueous electrolytic solution, such as a lithium ion secondary cell.

However, with lithium ion secondary cells, cell materials used include lithium having high chemical activity, a highly combustible electrolytic solution, and a lithium-transition metal composite oxide that is low in stability in an overcharged state. It is known that if charging is continued further in an overcharged state, the chemical reactions among the cell materials abruptly proceed, with the attendant problem that heat generation occurs in the cell. Accordingly, charging has to be stopped quickly before reaching the overcharged state, for which a mechanism of monitoring a voltage and suspending charging by means of an external circuit is adopted.

Such a mechanism of preventing heat generation of the cell is provided not only as an external circuit of the cell, but also inside the cell as is described below.

For example, in Patent Literature 1, there is disclosed an additive for electrolytic solutions, which is able to suppress overcharge in such a way that a material added to an electrolytic solution is oxidatively polymerized due to the voltage rise caused by overcharge, so that the internal resistance of the cell is increased.

In Patent Literature 2, there is also disclosed a procedure wherein an electrode resistance is increased by the temperature rise caused by overcharge thereby suppressing overcharge. More particularly, in the electrode of a type wherein an electrode mix layer made of a positive electrode material or a negative electrode material is stacked on a current collector, thermally expandable microcapsules are incorporated in the electrode mix layer or along the interface between the electrode mix layer and the current collector. When overcharged, the microcapsules are caused to foam, by which the electrode mix layer and the current collector are separated from each other, thereby leading to an increased electrode resistance.

In Patent Literature 3, there is disclosed a positive electrode wherein a compound contained in a positive electrode mix is decomposed due to a voltage rise resulting from overcharging thereby generating a gas, so that the internal resistance of a cell is increased to suppress further overcharging.

In Patent Literature 4, a positive electrode is disclosed as having a double-layer structure comprising a first layer made of a positive electrode current collector, a conductive agent, a binder and a substance capable of being decomposed at a high potential in an overcharged state, and a second layer formed on the first layer and made of a positive electrode active substance, a conductive agent and a binder. In the case where a high potential is developed due to the overcharging, the positive electrode configured in this way so acts that the substance capable of being decomposed at high potential is decomposed to generate a gas.

As a consequence, not only the first layer undergoes structural breakage, but also the interfacial breakage between the first layer and the second layer occurs. This leads to an increased internal resistance of the cell thereby blocking a charging current to suppress overcharging.

### CITATION LIST

### Patent Literature

### Patent Literature 1: JP-B-3938194

### Patent Literature 2: JP-B-4727021

### Patent Literature 3: JP-A-2008-181830

### Patent Literature 4: JP-B-4236308

### SUMMARY OF THE INVENTION

### Technical Problem

However, where an additive capable of suppressing overcharge as set out in Patent Literature 1 is mixed in an electrolytic solution, a problem has arisen in that the electrolyte ion conductivity in the electrolytic solution lowers. Additionally, another problem is involved in that the reaction of the additive occurs during high temperature storage, so that the cell cycle life and high temperature storage characteristics lower.

In the case where the microcapsules that are thermally expanded by temperature rise associated with overcharge are incorporated in a positive electrode, the microcapsules are gradually expanded during high temperature storage to increase a positive electrode resistance, with the attendant problem that the cell cycle life and high temperature storage characteristics lower.

In the case where a compound capable of generating a gas by decomposition caused by the voltage rise due to overcharging is introduced into a positive electrode mix as set forth in Patent Literature 3, an amount of an active substance in the positive electrode mix is reduced with the problem that the positive electrode capacity lowers.

Further, where a compound capable of generating a gas by decomposition caused by the voltage rise associated with overcharging is introduced into a first positive electrode layer on a current collector as described in Patent Literature 4, there arises a problem of increasing costs by the introduction of the gas-generating material.

The present invention has been made in view of such problems as stated above and has for its object the provision of an electrode for lithium ion secondary cells, wherein heat generation is better suppressed when in an overcharged state while attempting to hold down costs, and also of a lithium ion secondary cell provided with this electrode for lithium ion secondary cells.

### Possible Improvement or Solution to Problem

An electrode for a lithium ion secondary cell according to a first embodiment of the invention comprises a positive electrode current collector, a first positive electrode layer having a first binder, which is made of a synthetic polymer having an ester bond, and a first conductive agent and formed on the positive electrode current collector, and a second positive electrode layer having a positive electrode active substance, a second binder and a second conductive agent and formed on a surface of the first positive electrode layer opposite to the surface at which the positive electrode current collector is formed.

In the first embodiment, the synthetic resin may be any one of a polyester, a polyurethane, a polyester urethane, or combinations thereof.

A lithium ion cell according to a second embodiment of the invention comprises the electrode for a lithium ion secondary cell related to the first embodiment, a negative electrode capable of absorbing and releasing a lithium ion, and a non-aqueous electrolytic solution.

In the above second embodiment, when a potential difference between the electrode for a lithium ion secondary cell and the negative electrode reaches from 4.33 V to 4.76 V, inclusive, the first binder may start to undergo a change in its nature in such a way that an electric resistance of the first binder becomes greater.

In the second embodiment, the first binder may be changed in its nature by oxidative polymerization or oxidative decomposition.

### Possible Advantageous Effects of Invention

When using the electrode for lithium ion secondary cells and the lithium ion secondary cell according to the respective embodiments of the invention, heat generation can be better suppressed when in an overcharged state while perhaps also holding down fabrication costs.

### BRIEF DESCRIPTION OF THE DRAWINGS

FIG. 1 is a sectional view of a side face of an electrode for lithium ion secondary cells according to one embodiment of the invention.

FIG. 2 is a sectional view of a side face of a lithium ion secondary cell of an embodiment making use of the electrode for lithium ion secondary cells related to the one embodiment of the invention.

FIG. 3 is a sectional view of a side face of a lithium ion secondary cell of a comparative example in the invention.

### DESCRIPTION OF REPRESENTATIVE EMBODIMENTS

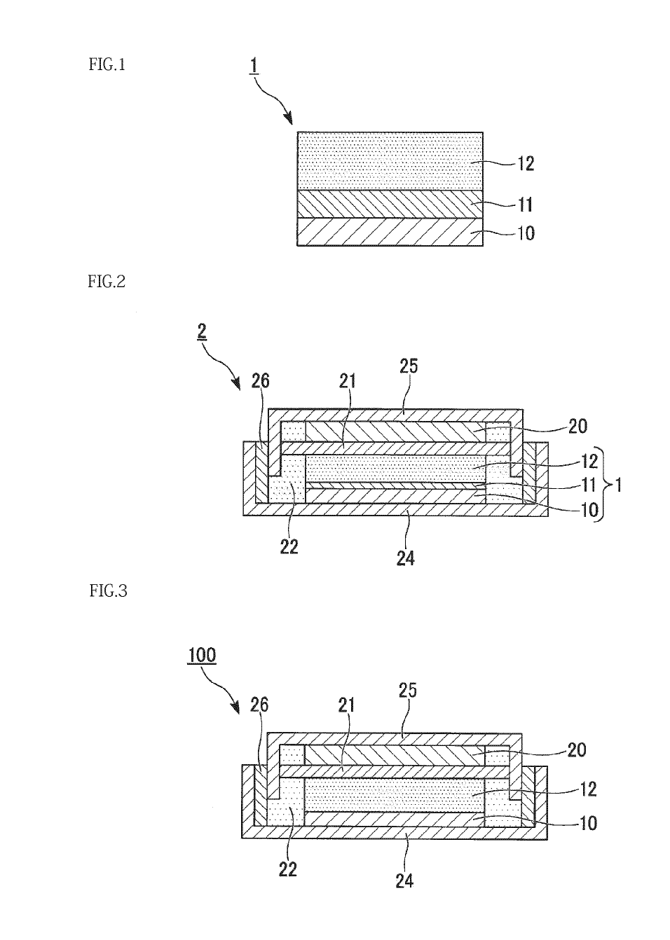

A positive electrode (electrode for lithium ion secondary cells) and a lithium ion secondary cell (which may be sometimes referred to simply as “cell” hereinafter) according to one embodiment of the invention are described with reference to FIGS. 1 to 3.

As shown in FIG. 1, a positive electrode 1 of the embodiment includes a positive electrode current collector 10, a first positive electrode layer 11 having a first binder and a first conductive agent and formed on the positive electrode current collector 10, and a second positive electrode layer 12 having a positive electrode active substance, a second binder and a second conductive agent and formed on a side of the first positive electrode layer 11 opposite to the side of the positive electrode current collector 10.

The positive electrode 1 has a double-layer configuration wherein the first positive electrode layer 11 and second positive electrode layer 12 are formed on the positive electrode current collector 10.

The configuration of the positive electrode 1 is now described below.

### (Positive Electrode)

The positive electrode current collector 10 is not specifically limited, for which there can be used a sheet-shaped material formed of a known material such as aluminum, a stainless steel, a nickel-plated steel or the like.

The first binder contained in the first positive electrode layer 11 should be made of a synthetic polymer that is capable of changing its nature under high voltage conditions, e.g. a synthetic polymer whose nature is changed by oxidative polymerization, oxidative decomposition or foaming, in the case where a lithium ion secondary cell becomes overcharged. As such a synthetic polymer, it is preferred to use those resins having an ester bond in the main chain. In particular, any one of a polyester, a polyurethane and a polyester urethane, or even combinations thereof, can be used.

As the first conductive agent contained in the first positive electrode layer 11, there can be used known materials such as, for example, acetylene black, ketjen black, carbon black, graphite (graphite), carbon nanotubes and the like.

The first positive electrode layer 11 can be formed by mixing the first binder and the first conductive agent in a single solvent or a mixed solvent such as of methyl ethyl ketone, toluene and the like, followed by coating onto the positive electrode current collector 10 and drying.

The positive electrode active substance contained in the second positive electrode layer 12 is not specifically limited, for which hitherto known active substances can be used. As a positive electrode active substance, mention is made, for example, of lithium-transition metal composite oxides capable of releasing lithium ions. Examples of the lithium-transition metal composite oxide include LiNiO₂, LiMnO₂, LiCoO₂, LiFePO₄ and the like. The mixtures of a plurality of lithium-transition metal composite oxides can also be used as a positive electrode active substance.

For the second binder contained in the second positive electrode layer 12, polyvinylidene fluoride (PVDF) and the like can be used as in the prior art. As a second conductive agent, there can be used graphite, aluminum and the like as in the prior art.

The second positive electrode layer 12 can be formed by mixing the positive electrode active substance, the second binder and the second conductive agent in a solvent such as N-methylpyrrolidone (NMP) or the like, followed by coating and stacking on the first positive electrode layer 11 and drying.

In the case where the first positive electrode layer 11 and the second positive electrode layer 12 are formed according to a continuous manufacturing process, the drying of the first positive electrode layer has to be carried out within a short time. To this end, the solvent of a liquid composition for the formation of the first positive electrode layer 11 should desirably be selected from low boiling solvents. Accordingly, it is preferred to select, as a first binder of the first positive electrode layer 11, a resin capable of being dissolved in such a low boiling solvent as indicated above.

The positive electrode 1 of this embodiment arranged as set out above is used to configure a lithium ion secondary cell 2 of the present embodiment along with a negative electrode 20, a separator 21 for preventing the contact between the positive electrode 1 and the negative electrode 20, and a non-aqueous electrolytic solution 22 immersing the negative electrode 20 and the separator therewith.

The components other than the positive electrode 1 of the lithium ion secondary cell 2 are now described below.

### (Negative Electrode)

The negative electrode active substance contained in the negative electrode 20 is not specifically limited, for which compounds capable of absorbing and releasing lithium ions and including metal materials such as lithium and the like, alloy materials containing silicon, tin and the like, and carbon materials such as graphite, coke and the like can be used singly or in combination. Where a lithium metal foil is used as a negative electrode active substance, the negative electrode 20 can be formed by subjecting a lithium foil to pressure-bonding to a negative electrode current collector such as of copper. On the other hand, where an alloy material or carbon material is used as a negative electrode active substance, a negative electrode active substance, a binder, a conductive aid and the like are mixed in water or a solvent such as N-methylpyrrolidone, followed by coating onto a negative electrode current collector made of a metal such as copper or the like and drying to enable the formation of the negative electrode 20.

Preferred binders include chemically and physically stable materials such as polyvinylidene fluoride, polytetrafluoroethylene, EPDM, SBR, NBR, fluorine rubber and the like. For the conductive aid, mention can be made of ketjen black, acetylene black, carbon black, graphite, carbon nanotubes, amorphous carbon and like.

The negative electrode current collector is not specifically limited, and a current collector formed of a copper foil can be used therefor.

### (Non-Aqueous Electrolytic Solution)

The non-aqueous electrolytic solution 22 is not specifically limited, for which mention can be made of an electrolytic solution obtained by dissolving a supporting electrolyte in a solvent such as an organic solvent, an ionic liquid that is an electrolyte serving also as a solvent, an electrolytic solution obtained by further dissolving a supporting salt in the ionic liquid, and the like

Usable organic solvents include carbonates, halogenated hydrocarbons, ethers, ketones, nitriles, lactones, oxolane compounds and the like. Mixed solvents may also be used including those of propylene carbonate, ethylene carbonate, 1,2-dimethoxyethane, dimethyl carbonate, diethyl carbonate, ethyl methyl carbonate and the like.

The supporting salts used in the non-aqueous electrolytic solution 22 are not specifically limited, and mention can be made, for example, of LiPF₆, LiBF₄, LiClO₄, LiAsF₆, LiCF₃SO₃, LiN(CF₃SO₂)₂, LiC(CF₃SO₂)₃, LiN(FSO₂)₂, LiN(CF₃SO₂)(C₄F₉SO₂), LiN(CF₃SO₂)₂ and the like.

The ionic liquid used as the non-aqueous electrolytic solution 22 is not specifically limited so far as it is liquid at a normal temperature, and mention can be made, for example, of an alkylammonium salt, a pyrrolidinium salt, a pyrazolium salt, a piperidinium salt, an imidazolium salt, a pyridinium salt, a sulfonium salt, a phosphonium salt and the like. The ionic liquid should further preferably be electrochemically stable over a wide potential range.

### (Separator, Lithium Ion Secondary Cell)

The separator 21 includes a microporous membrane or non-woven fabric made of a polyolefin such as polyethylene, polypropylene or the like, or an aromatic polyamide resin, a porous resin coat containing inorganic ceramic powder.

The positive electrode 1, negative electrode 20, non-aqueous electrolytic solution 22, and separator 21 are accommodated in a positive electrode case 24 and a negative electrode case 25, respectively, shown in FIG. 2 for the purpose of preventing the leakage of the electrolytic solution and also preventing outside air from entering. As a result, there can be made a coin-shaped lithium ion secondary cell 2. The cases 24, 25 are formed of a metal sheet, respectively.

It will be noted that the positive electrode case 24 and the negative electrode case 25 are sealed therebetween with a gasket 26 having insulating properties.

### EXAMPLES

Examples of the lithium ion secondary cell 2 of the present invention and comparative examples related thereto are described in detail, and the lithium ion secondary cell of the invention should not be construed as limited thereto.

### Example 1

Initially, 30 parts by mass of acetylene black (HS-100, manufactured by Denka Co., Ltd.) and 70 parts by mass of polyester A (with a molecular weight of 17,000 and Tg (glass transition point) of 67° C., first binder) were added to a mixed solvent of methyl ethyl ketone (MEK) and toluene and subjected to dispersion treatment to obtain a homogeneous paste. This paste was applied onto an aluminum foil current collector (with a thickness of 20 μm (micrometers), positive electrode current collector) and dried to obtain a first positive electrode layer. The thickness of the first positive electrode layer after the drying treatment was 1-2 μm.

Next, 92 parts by mass of LiMnO₂ (manufactured by Nihon Kagaku Sangyo Co., Ltd.), 5 parts by mass of acetylene black (HS-100, manufactured by Denka Co., Ltd.) and 3 parts by mass of polyvinylidene fluoride (#7200, manufactured by Kureha Battery Materials Japan Co., Ltd.) were added to N-methylpyrrolidone and dispersed to prepare a homogeneous paste. This paste was applied onto the first positive electrode layer and subjected to drying treatment to obtain a second positive electrode layer. The thickness of the second positive electrode layer after the drying treatment was 100 μm. The positive electrode after the drying treatment was pressed so that the density of the positive electrode was at about 2.6 g/cm².

The thus obtained positive electrode was punched to a diameter of 13.5 mm, and a lithium foil having a diameter of 15 mm was provided as a negative electrode. The positive and negative electrodes were inserted in position through a polyolefin or polyethylene separator (Hipore, manufactured by Asahi Kasei E-materials Corporation).

LiPF₆ (lithium hexafluorophosphate) was added to a mixed organic solvent, which was obtained by mixing ethylene carbonate and diethyl carbonate at a ratio by volume of 3:7, at a concentration of 1 mole/L. A non-aqueous electrolytic solution prepared by further adding 2% by weight of vinylene carbonate was charged, thereby providing a coin-shaped cell 2.

It will be noted that when compared with the cell 2 of the example, a coin-shaped cell 100 of Comparative Example 1 shown in FIG. 3 is not provided with the first positive electrode layer 11.

### Example 2

In the same manner as in Example 1, cell 2 was made except that polyester B (with a molecular weight of 15,000 and Tg of 60° C.) different from polyester A was used, as the first binder of the first positive electrode layer, in place of polyester A.

### Example 3

In the same manner as in Example 1, cell 2 was made using polyester C (with a molecular weight of 23,000 and Tg of 67° C.) as the first binder of the first positive electrode layer.

### Example 4

In the same manner as in Example 1, cell 2 was made using polyester D (with a molecular weight of 18,000 and Tg of 68° C.) as the first binder of the first positive electrode layer.

### Example 5

In the same manner as in Example 1, cell 2 was made using polyester E (with a molecular weight of 22,000 and Tg of 72° C.) as the first binder of the first positive electrode layer.

### Example 6

In the same manner as in Example 1, cell 2 was made using polyester F (with a molecular weight of 14,000 and Tg of 71° C.) as the first binder of the first positive electrode layer.

### Example 7

In the same manner as in Example 1, cell 2 was made using polyester G (with a molecular weight of 11,000 and Tg of 36° C.) as the first binder of the first positive electrode layer.

### Example 8

In the same manner as in Example 1, cell 2 was made using polyester H (with a molecular weight of 18,000 and Tg of 84° C.) as the first binder of the first positive electrode layer.

### Example 9

In the same manner as in Example 1, cell 2 was made except that the above polyester F was used as the first binder of the first positive electrode layer, but this first binder was subjected to stoichiometric crosslinking with hexamethylene diisocyanate.

### Example 10

In the same manner as in Example 1, cell 2 was made except that polyurethane A (with a molecular weight of 20,000 and Tg of 68° C.) was used as the first binder of the first positive electrode layer 1, followed by stoichiometric crosslinking with hexamethylene diisocyanate.

### Example 11

In the same manner as in Example 1, cell 2 was made except that polyurethane B (with a molecular weight of 30,000 and Tg of 46° C.) was used as the first binder of the first positive electrode layer 1, followed by stoichiometric crosslinking with hexamethylene diisocyanate.

### Example 12

In the same manner as in Example 1, cell 2 was made except that polyester urethane A (with a molecular weight of 40,000 and Tg of 83° C.) was used as the first binder of the first positive electrode layer 1, followed by stoichiometric crosslinking with hexamethylene diisocyanate.

### Example 13

In the same manner as in Example 1, cell 2 was made except that polyester urethane B (with a molecular weight of 25,000 and Tg of 73° C.) was used as the first binder of the first positive electrode layer 1, followed by stoichiometric crosslinking with hexamethylene diisocyanate.

### Comparative Example 1

In the same manner as in Example 1, cell 100 was made using a positive electrode wherein a second positive electrode layer, which was formed of 92 parts by weight of LiMnO₂ (manufactured by Nihon Kagaku Sangyo Co., Ltd.), 5 parts by weight of acetylene black (HS-100, manufactured by Denka Co., Ltd.) and 3 parts by weight of polyvinylidene fluoride (#7200, manufactured by Kureha Battery Materials Japan Co., Ltd.), was formed on an aluminum foil current collector (with a thickness of 20 μm, positive electrode current collector) without formation of a first positive electrode layer.

### Comparative Example 2

In the same manner as in Example 1, a cell was made except that acrylic polyol A (with a molecular weight of 10,000 and Tg of 88° C.) was used as the first binder of the first positive electrode layer, followed by stoichiometric crosslinking with hexamethylene diisocyanate.

### Comparative Example 3

In the same manner as in Example 1, a cell was made except that acrylic polyol B (with a molecular weight of 37,000 and Tg of 77° C.) was used as the first binder of the first positive electrode layer, followed by stoichiometric crosslinking with hexamethylene diisocyanate.

### Comparative Example 4

In the same manner as in Example 1, a cell was made except that acrylic polyol C (with a molecular weight of 23,000 and Tg of 60° C.) was used as the first binder of the first positive electrode layer, followed by stoichiometric crosslinking with hexamethylene diisocyanate.

### Comparative Example 5

In the same manner as in Example 1, a cell was made except that acrylic polyol D (with a molecular weight of 16,000 and Tg of 52° C.) was used as the first binder of the first positive electrode layer, followed by stoichiometric crosslinking with hexamethylene diisocyanate.

### Comparative Example 6

In the same manner as in Example 1, a cell was made except that acrylic polyol A was used as the first binder of the first positive electrode layer, and 5 wt % of lithium carbonate was further added.

### (Evaluation of the Positive Electrodes)

For the evaluation of the positive electrodes, the electrochemical behavior of the first positive electrode layer was checked. More particularly, there was made a two-pole cell (i.e. cell 100 of the comparative example) having the above first positive electrode layer as a working electrode (positive electrode) and a lithium metal as a counter electrode (negative electrode). Using a potentio/galvanostat device (Model 1287, manufactured by Solartron Inc.) and a frequency response analyzer (Model 1260, manufactured by Solartron Inc.), a difference in potential between the positive electrode and the negative electrode was measured while sweeping at a sweep rate of 5 mV/s (millivolts per second) within a potential range of 3.0-5.0 V so as to carry out cyclic voltammetric (CV) measurement.

In the CV measurement of the cell 100, a voltage (i.e. the above-indicated potential difference) at the time when an oxidation current of 0.05 mA/cm² was observed was determined as an oxidation initiation potential (i.e. a potential of initiating a change in nature) of the first binder contained in the first positive electrode layer.

When a potential difference between the positive electrode and the negative electrode became so great that the first binder reached the oxidation initiation potential, the first binder initiated a change in its nature, so that an electric resistance of the first binder became great.

### (Evaluation of Cell Discharge Capacity)

The cells 2 of the examples were used, and were charged up to 4.3 V by constant current and constant voltage charging and discharged down to 3.0 V by constant current discharging. Initially, charging and discharging at 0.1 C were repeated twice, followed by charging at 0.2 C. Thereafter, measurement was performed in the order of discharge at 0.2 C, 1 C, 2 C, 4 C, 6 C and 10 C to obtain a discharge capacity rate characteristic. It will be noted that the setting was such that migration to constant current discharge occurred after a current value had lowered to 0.01 mA by constant voltage charge.

Charge and discharge at 0.1 C were repeated twice by use of the cell 2, after which cycle characteristics were evaluated by repeating charge at 0.2 C and discharge at 1 C. It will be noted that the setting was such that migration to constant current discharge occurred after a current value had lowered to 0.01 mA by constant voltage charge.

### (Evaluation of Cell Overcharge)

Like the above evaluation of the discharge capacity, the cells 2 of the examples were used, followed by charging to 4.3 V by constant current and constant voltage charge and discharge to 3.0 V by constant current discharge.

Initially, break-in charge and discharge at 0.1 C were carried out twice. Next, for a first cycle of charge and discharge, charge and discharge at 4.3 V and 0.2 C were carried out once. Thereafter, for a second cycle of charge and discharge, constant current and constant voltage charge was performed up to 4.8 V by 0.2 C charge so as to perform overcharge, followed by 0.2 C discharge. Moreover, for a third cycle of charge and discharge, charge and discharge at 4.3 V and 0.2 C were performed once. A dropped voltage value at 60 seconds after commencement of the 0.2 C discharge at the third cycle of charging and discharging was defined as a drop voltage.

### [Test Results 1]

In Table 1, the CV characteristics of the cells of the examples and comparative examples are shown. The oxidation initiation potential in the table means a potential (V) against the lithium metal (Li) negative electrode. It was found that with the cells of Examples 1 to 6 and 10 to 13, the first positive electrode layer underwent oxidation reaction from a relatively low potential of 4.5 V or less. It was also found that with the cells of Examples 7, 8, the first positive electrode layer underwent oxidation reaction at a relatively high potential of 4.5 V or over.

With the cell of Comparative Example 6 having the first binder, to which lithium carbonate was added to acrylic polyol A, it was found that the oxidation initiation potential of the first binder lowered from 4.8 V of Comparative Example 2 to 4.46 V.

With the cells of Comparative Examples 2 to 5, it was found that although the acrylic polyol of the first binder was thermally cross-linked, the oxidation initial potentials of the first binder were all not less than 4.8 V. In addition, with the cell 2 of Example 9 having the first binder wherein the polyester F was thermally cross-linked, it was found that the oxidation initiation potential was in the vicinity of 4.5 V.

More particularly, with the cells 2 of Examples 1 to 13, the oxidation initiation potential of the first binder is from about 4.3 V to about 4.8 V, more specifically from about 4.33V to about 4.76.

TABLE 1

| | | Presence or | Presence or | |
|---|---|---|---|---|
| | Type of first | absence of | absence of | Oxidation |
| | binder of | addition of | addition of | initiation |
| | first positive | crosslinking | lithium | potential |
| | electrode layer | agent | carbonate | (V v.s. Li) |
| Example 1 | Polyester A | No | No | 4.40 |
| Example 2 | Polyester B | No | No | 4.42 |
| Example 3 | Polyester C | No | No | 4.38 |
| Example 4 | Polyester D | No | No | 4.42 |
| Example 5 | Polyester E | No | No | 4.48 |
| Example 6 | Polyester F | No | No | 4.42 |
| Example 7 | Polyester G | No | No | 4.60 |
| Example 8 | Polyester H | No | No | 4.76 |
| Example 9 | Polyester F | Yes | No | 4.48 |
| Example 10 | Polyurethane A | Yes | No | 4.34 |
| Example 11 | Polyurethane B | Yes | No | 4.33 |
| Example 12 | Polyester | Yes | No | 4.36 |
| | urethane A | | | |
| Example 13 | Polyester | Yes | No | 4.38 |
| | urethane B | | | |
| Comparative | Acrylic | Yes | No | 4.80 |
| Example 2 | polyol A | | | |
| Comparative | Acrylic | Yes | No | 4.80 |
| Example 3 | polyol B | | | |
| Comparative | Acrylic | Yes | No | 4.80 |
| Example 4 | polyol C | | | |
| Comparative | Acrylic | Yes | No | 4.80 |
| Example 5 | polyol D | | | |
| Comparative | Acrylic | No | Yes | 4.46 |
| Example 6 | polyol A | | | |

### [Test Results 2]

In view of the cell discharge characteristics of the examples and comparative examples shown in Table 2, it was revealed that when compared with the cell 100 of Comparative Example 1 having no first positive electrode layer, the cells 2 of Examples 1 to 13 showed substantially the same level of 0.2 C discharge capacity.

It was found that the capacity ratio of the 4 C discharge capacity to the 0.2 C discharge capacity was at 0.76-0.80 for all the cells of Examples 1 to 13, which showed the 4 C discharge capacities substantially at the same level of the cell 100 of Comparative Example 1 and the cells of Comparative Examples 2 to 6.

Further, it was also found that the 50th cycle capacity retention ratio was as high as 92-95% irrespective of the presence or absence of the first positive electrode layer. On the other hand, with the cell having a first positive electrode layer wherein lithium carbonate was added to acrylic polyol A, the capacity ratio of the 4 C discharge capacity to the 0.2 C discharge capacity was 0.73. Accordingly, it was seen that when compared with the first positive electrode layer having the first binder to which lithium carbonate was added, the lithium carbonate-free first positive electrode layers as shown in Examples 1 to 13 showed higher cell characteristics.

TABLE 2

| | 0.2 C | 4 C discharge | 50th cycle |
|---|---|---|---|
| | discharge | capacity/0.2 C | capacity |
| | capacity | discharge | retention |
| | (mAh/g) | capacity | rate (%) |
| Example 1 | 103 | 0.78 | 95 |
| Example 2 | 104 | 0.79 | 94 |
| Example 3 | 103 | 0.78 | 93 |
| Example 4 | 103 | 0.79 | 95 |
| Example 5 | 104 | 0.79 | 94 |
| Example 6 | 103 | 0.79 | 95 |
| Example 7 | 103 | 0.79 | 95 |
| Example 8 | 104 | 0.80 | 94 |
| Example 9 | 104 | 0.79 | 95 |
| Example 10 | 102 | 0.76 | 92 |
| Example 11 | 103 | 0.77 | 95 |
| Example 12 | 104 | 0.79 | 95 |
| Example 13 | 104 | 0.79 | 95 |
| Comparative | 103 | 0.80 | 95 |
| Example 1 | | | |
| Comparative | 103 | 0.79 | 95 |
| Example 2 | | | |
| Comparative | 103 | 0.79 | 95 |
| Example 3 | | | |
| Comparative | 104 | 0.79 | 95 |
| Example 4 | | | |
| Comparative | 104 | 0.79 | 95 |
| Example 5 | | | |
| Comparative | 102 | 0.72 | 94 |
| Example 6 | | | |

### [Test Results 3]

From the overcharge characteristics of the cells and also of the cells of the comparative examples shown in Table 3, it was found that with the cell 100 of Comparative Example 1 using the positive electrode not provided with a first positive electrode layer, the drop voltage was 0.2 V. When using positive electrodes wherein acrylic polyols A to D were adopted as a first binder of the first positive electrode layer and a second positive electrode layer was stacked, the drop voltages were substantially at the same level of 0.2-0.3 V. Moreover, with the cell of Comparative Example 6 making use of a positive electrode wherein a second positive electrode layer was stacked on a first positive electrode layer having lithium carbonate added to acrylic polyol A, the drop voltage was at 0.6 V.

On the other hand, the drop voltages of the cells 2 of Examples 1 to 9 making use of polyester A to polyester H as a first binder of the first positive electrode layer were at 0.4-0.6 V, and those drop voltages of the cells 2 of Examples 10 to 13 making use of polyurethanes A and B and polyester urethanes A and B were at 0.4-0.5 V. In view of the above results, it was found that when there was used a first positive electrode layer including a first binder having an oxidation initiation potential in the vicinity of 4.4-4.8 V, the drop voltages immediately after commencement of discharge in the charge and discharge test after the overcharge test were substantially at the same level of 0.4-0.6 V as the cell of Comparative Example 6 having a first binder to which lithium carbonate was added.

Accordingly, it has been considered that the first positive electrode layers in the cells 2 of Examples 1 to 13 have the effect of increasing an internal resistance and suppressing overcharge like the first positive electrode layer having a first binder, to which lithium carbonate was added.

TABLE 3

| | Presence or absence of | Drop voltage |
|---|---|---|
| | addition of crosslinking agent | (V) |
| Example 1 | No | 0.5 |
| Example 2 | No | 0.5 |
| Example 3 | No | 0.5 |
| Example 4 | No | 0.6 |
| Example 5 | No | 0.6 |
| Example 6 | No | 0.6 |
| Example 7 | No | 0.4 |
| Example 8 | No | 0.4 |
| Example 9 | Yes | 0.5 |
| Example 10 | Yes | 0.5 |
| Example 11 | Yes | 0.5 |
| Example 12 | Yes | 0.4 |
| Example 13 | Yes | 0.5 |
| Comparative | — | 0.2 |
| Example 1 | | |
| Comparative | Yes | 0.2 |
| Example 2 | | |
| Comparative | Yes | 0.2 |
| Example 3 | | |
| Comparative | Yes | 0.3 |
| Example 4 | | |
| Comparative | Yes | 0.2 |
| Example 5 | | |
| Comparative | No | 0.6 |
| Example 6 | | |

From the above test results, it was found that when comparing with the cell 100 of the comparative example having no first positive electrode layer, the cells 2 of the examples, which had an oxidation initiation potential of not less than 4.3 V and adopted in the first positive electrolyte layer a first binder having an oxidation initiation potential of not larger than 4.8 V that corresponded to an oxidative decomposition initiation potential of the electrolytic solution and wherein a second positive electrode layer was stacked, were such that the first binder was changed in its nature under overcharged conditions thereby causing its resistance to rise. The rise of the resistance of the first binder can at least partially mitigate an increasing rate of the potential difference between the positive electrode and the negative electrode.

It was found that when comparing with the first positive electrode layer having a first binder to which lithium carbonate was added, the cells 2 of Examples 1 to 13 showed an internal resistance rise substantially in the same way. Accordingly, with the cells 2 of Examples 1 to 13, the temperature rise can at least be partially mitigated due to the internal resistance rise, so that the shut-down function based on the separator can be more reliably developed.

Further, it was confirmed that when compared with the cell 100 of the comparative example having no first positive electrode layer, the discharge capacities and cycle performances of the cells 2 of Examples 1 to 13 were substantially at the same level, respectively. Moreover, it was also found that there was shown a better cell performance than a capacity ratio of the 4 C discharge capacity to the 0.2 C discharge capacity of the first positive electrode layer having a first binder, to which lithium carbonate was added. Accordingly, the positive electrodes of the cells 2 of Examples 1 to 13 are improved or even excellent in either or both the overcharge suppression capability and cell performance.

As stated hereinabove, according to the positive electrode 1 and the lithium ion secondary cell 2 of the present embodiment, some fabrication costs can be saved because of no use of a material capable of generating a gas for the positive electrode 1. When the cell 2 is overdischarged, the first binder is changed in its nature so as to increase the resistance, with the result that the rise rate of the potential difference between the positive electrode 1 and the negative electrode 20 is at least partially mitigated, thereby enabling heat generation under overdischarged conditions to be better suppressed.

The present inventors have made intensive studies so as to solve the foregoing problems of the invention and, as a result, found that the first positive electrode layer is configured to adopt a first binder whose nature is changed due to the voltage rise associated with overdischarge without use of a compound capable of generating a gas by decomposition due to the voltage rise associated with overdischarge. This configuration is such that the first positive electrode layer has only a first conductive agent made of a conductive filler and a first binder.

The adoption of such a configuration as stated above enables improved safety while avoiding cost rise due to the use of an additive material without complicating the step of preparing a solution for the first positive electrode layer.

For the first binder, the use of a binder capable of being dissolved in low boiling solvents enables the drying time of a first positive electrode layer to be shortened and costs to be saved by virtue of continuous coating of the first positive electrode layer and second positive electrode layer.

Since the first binder is soluble in a low boiling solvent such as methyl ethyl ketone or toluene, the coating and drying steps of the first positive electrode layer can be completed within a very short time. Accordingly, the first positive electrode layer and second positive electrode layer can be formed by a continuous fabrication process, thus making it possible to suppress the increase of electrode fabrication costs.

One embodiment of the present invention has been described in detail with reference to the accompanying drawings. The present invention should not be construed as limited to this embodiment, which can be altered, combined and deleted within a range not departing from the spirit of the invention.

### REFERENCE SIGNS LIST

1 positive electrode (electrode for lithium ion secondary cell)
2 cell (lithium ion secondary cell)
10 positive electrode current collector
11 first positive electrode layer
12 second positive electrode layer
20 negative electrode
22 non-aqueous electrolytic solution

What is claimed is:

1. An electrode for lithium ion secondary cells, comprising:
a positive electrode current collector;
a first positive electrode layer having a first binder made of a synthetic polymer having an ester bond and a first conductive agent, and formed on the positive electrode current collector; and
a second positive electrode layer having a positive electrode active substance, a second binder and a second conductive agent, and formed on a surface of the first positive electrode layer opposite to the surface formed on the positive electrode current collector.

2. The electrode of claim 1, wherein the synthetic polymer is any one of a polyester, a polyurethane, a polyester urethane, and combinations thereof.

3. A lithium ion secondary cell comprising:
the electrode for lithium ion secondary cells of claim 1;
a negative electrode capable of absorbing and releasing lithium ions; and
a non-aqueous electrolytic solution.

4. A lithium ion secondary cell comprising:
the electrode for lithium ion secondary cells of claim 2;
a negative electrode capable of absorbing and releasing lithium ions; and
a non-aqueous electrolytic solution.

5. The lithium ion secondary cell of claim 3, wherein when a potential difference between the electrode for lithium ion secondary cells and the negative electrode ranges from about 4.33 V to about 4.76 V, then a change in nature of the first binder is started to increase an electric resistance of the first binder.

6. The lithium ion secondary cell of claim 4, wherein when a potential difference between the electrode for lithium ion secondary cells and the negative electrode ranges from about 4.33 V to about 4.76 V, then a change in nature of the first binder is started to increase an electric resistance of the first binder.

7. The lithium ion secondary cell of claim 3, wherein the first binder is changed in its nature by oxidative polymerization or oxidative decomposition.

8. The lithium ion secondary cell of claim 4, wherein the first binder is changed in its nature by oxidative polymerization or oxidative decomposition.

9. The lithium ion secondary cell of claim 5, wherein the first binder is changed in its nature by oxidative polymerization or oxidative decomposition.

10. The lithium ion secondary cell of claim 6, wherein the first binder is changed in its nature by oxidative polymerization or oxidative decomposition.
